(19) United States
(12) Patent Application Publication
(10) Pub. No.: US 2017/0215605 A1
(43) Pub. Date: Aug. 3, 2017

(54) RODAWAY FISHING ROD RACK AND CARRIER

(71) Applicant: GEORGE READER MAGILL, Sebastian, FL (US)

(72) Inventor: GEORGE READER MAGILL, Sebastian, FL (US)

(21) Appl. No.: 15/009,392

(22) Filed: Jan. 28, 2016

(51) Int. Cl. A47F 7/00; F16M 13/02; A45F 5/00; A47F 5/08

(52) U.S. Cl. CPC A47F 7/0021; A47F 5/08; F16M 13/02; A45F 5/00

(57) ABSTRACT

A cee shaped fishing rod and reel storage rack and carrier molded from polystyrene plastic with apertures with one end flange for accepting the handle portion of one or more fishing rods, and an opposing end flange notched to receive the tapered shanks of said rods. The openings are sized to accommodate most combinations of conventional rods and reels. Recessed keyhole slots are provided for easy attachment to wall or overhead.

### BACKGROUND OF THE INVENTION

The present invention relates to a storage rack and carrier for one or more fishing rods and reels, and more particularly to a carrier by which a limited number of fishing rods, with or without reels; can be stored and/or transported easily and safely; all in one hand, when placed over the handle of either a (5) gallon bucket or fishing tackle box.

A number of carriers for fishing rods and reels have been developed in the past, including those disclosed in Wright U.S. Pat. No. 3,764,190 and Morin U.S. Pat. No. 4,311,262. While these carriers are effective in performing the function of supporting a number of fishing rods and reels; the structure involved by which this is achieved is relatively complicated and adds greatly to the weight and expense of the carrier. It is, therefore, more desirable to provide an improved design for a fishing rod and reel carrier for storing and transporting fishing rods, reels, (5) gallon buckets, or tackle boxes; in a more efficient and economical way; all in one hand.

It is another object of this present invention to be of lightweight construction while maintaining the necessary rigidity for not only the storage function; but also the transporting aspect.

It is a further object of this invention to provide a fishing rod rack and carrier that efficiently nests in small cartons for ease of distribution.

### BRIEF SUMMARY OF THE INVENTION

The present invention provides for an efficient method for storing one or more fishing rods, with or without reels, either vertically or horizontally. And when ready to fish, easy removal of the stored unit with rods and reels; and placement over the handle of a (5) gallon bucket or fishing tackle box handle, for easy transport; all in one hand.

### BRIEF DESCRIPTION OF THE SEVERAL VIEWS OF THE DRAWINGS

FIG. 1: Front perspective view of the unit empty

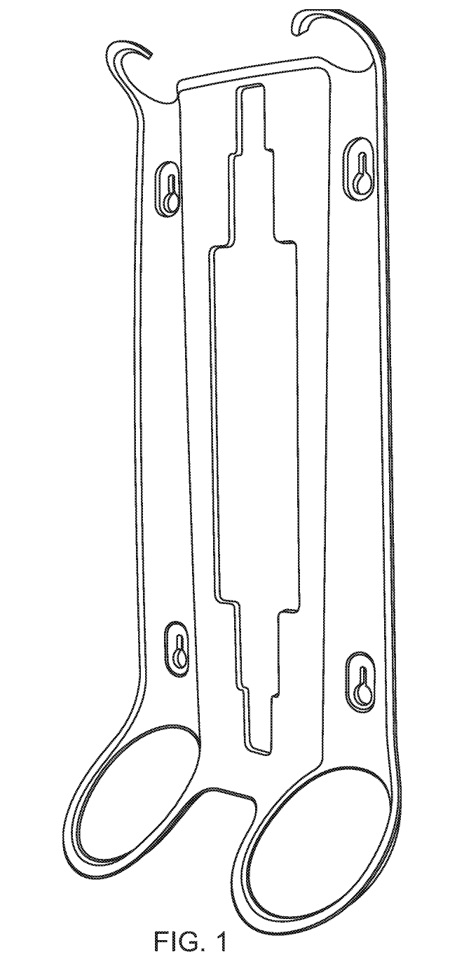

FIG. 2: Rear perspective view empty

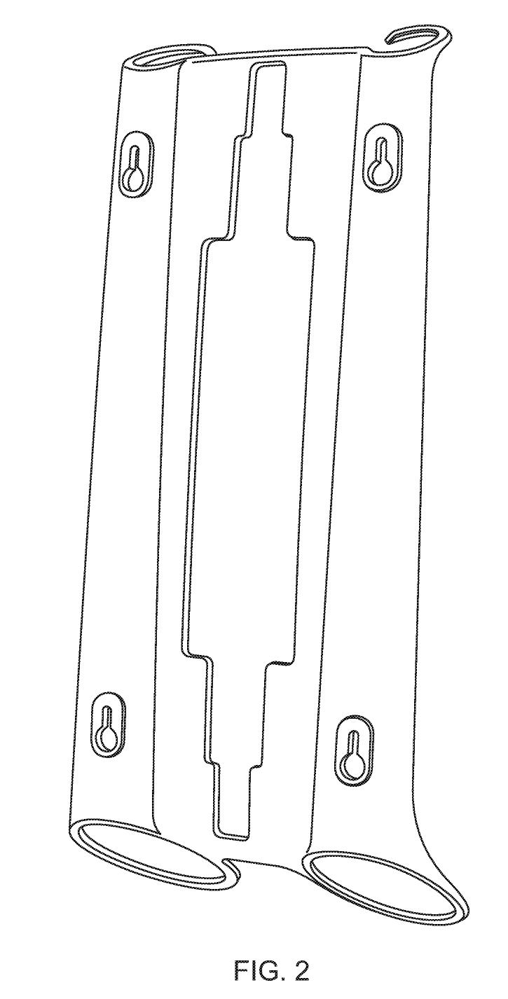

FIG. 3: Front view of product hanging on a wall.

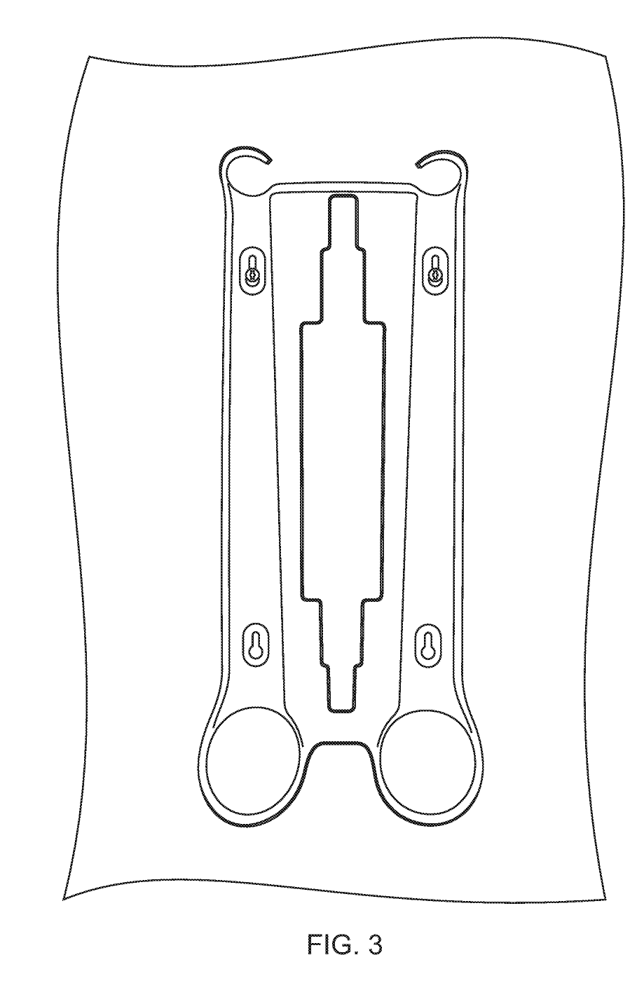

FIG. 4: Product shown on a (5) gallon bucket with fishing rods in place.

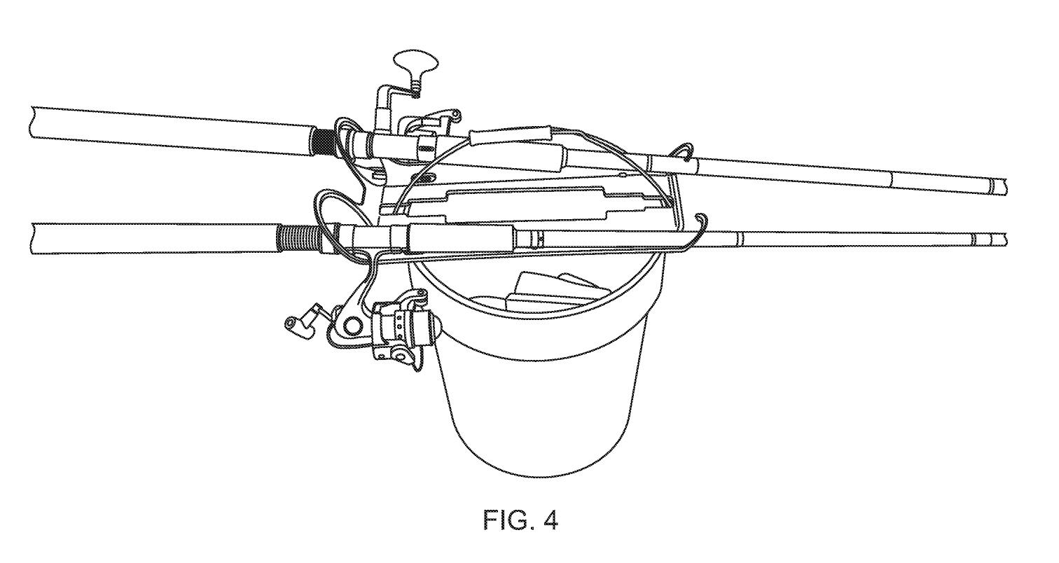

FIG. 5: Front view of product hanging on the wall with fishing rods in place.

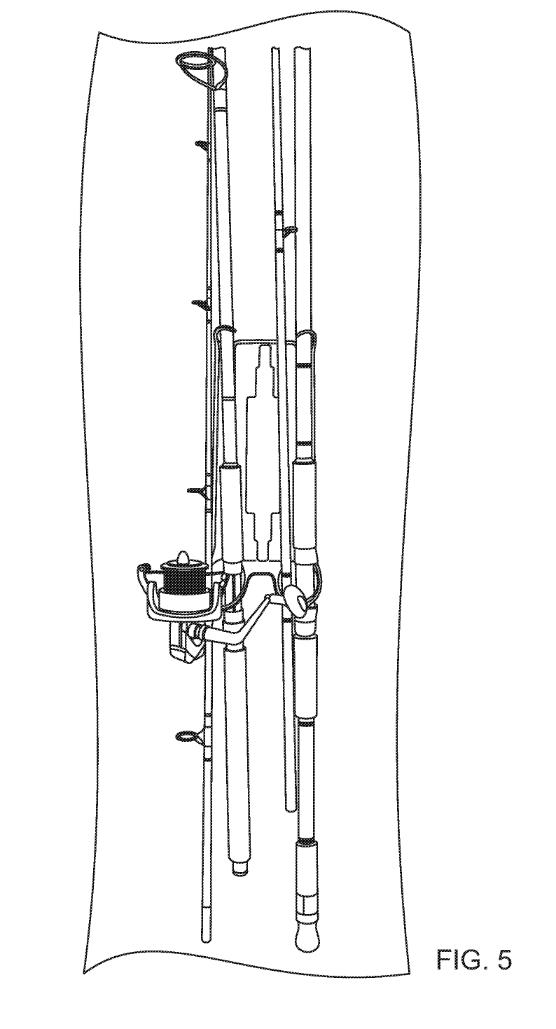

FIG. 6: Product shown on tackle box empty.

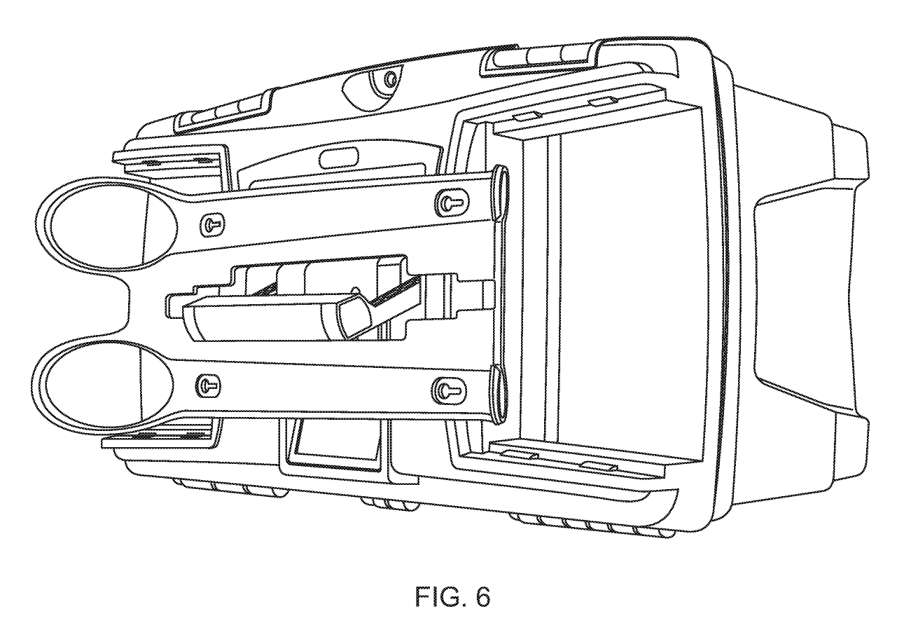

FIG. 7: Product shown on tackle box with fishing rods in place.

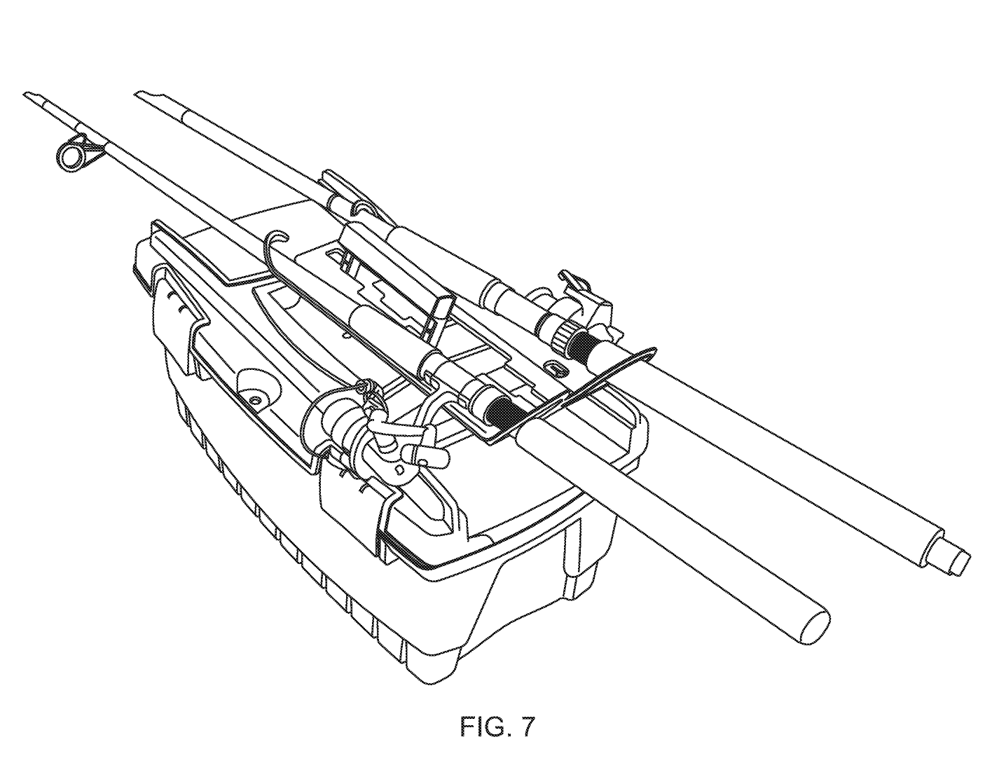

### DETAILED DESCRIPTION OF THE INVENTION

The present invention construction is of injection molded polystyrene plastic. Polystyrene polymer pellets are heated, then injected into a two piece aluminum mold, consisting of a male side and a female side. Cooling yields an economically produced one piece cee shaped fishing rod and reel storage rack and carrier.

It will become apparent from the foregoing that the present invention provides a simple and economical apparatus for storing and carrying a plurality of fishing rods and reels, over either (5) gallon buckets or tackle boxes; and for maintaining them in a spaced situation, thus preventing any potential damage from contact with each other. Because of the design; these units can be nested in a corrugated carton, (12) to a package, palletized, and distributed as necessary.

This present invention has an overall length of 16.00 inches, a heel length of 13.00 inches and an overall width at bottom (reel) end of 7.25 inches. Overall width at opposite end is 5.875 inches. Two 3.3125 inch×2.375 inch oval shaped apertures on 4.5 1.375 inch×1.00 inch oval shaped apertures allow for placement of tapered rod shanks. There are (3) overlapping slots in the heel of the unit. Slot one is 13″×0.625″ for accommodating wire handle of (5) gallon buckets. Slot two is 1.00 inch×10.375 inch for accommodating live bait buckets. Slot three is 2.00 inch×6.875 inch for accommodating a myriad of tackle box handles. The mounting pattern also within the heel of the unit consists of (4) recessed keyhole slots placed in a pattern of 4.50 inches×9.375 inches. The slot shape allows gravity to lock unit in place when storing vertically.

For vertical mounting, place screws or molly bolts only in the top two slots; while overhead mounting would demand screws or molly bolts in all four positions. When ready to remove from wall; simply push rack up, with rod(s) and reel(s) in place; and remove. For overhead removal; simply slide unit forward, with rod(s) and reel(s) in place.

I claim:

1. A wall mounted rack for storing one or two fishing rods with or without reels comprising: a one piece cee shaped apparatus having two oval shaped apertures in one leg for accommodating fishing rod handles, and two notched openings in the other leg for handling tapered rod shafts; and (4) keyhole slots in the heel section for securing said rack to the wall.

2. The rack of claim 1 wherein said rack is secured vertically to a wall with (2) Molly bolts or screws through (2) upper position keyhole slots.

3. The rack of claim 1 wherein said rack is made from Polystyrene injection molded plastic.

4. The rack of claim 1 wherein a center elongated slot is added to the center heel to accommodate the handle of a (5) gallon bucket.

5. The rack of claim 1 wherein an additional elongated slot is added to the center of the heel section to accommodate the handle of a tackle box.

6. A method for using the rod rack of claim 1, the method comprising: initially installing an empty said rack on a wall, then loading with said rods and reels, by inserting fishing rod handles down first through bottom leg of rack, and then pushing upper part of tapered rod shafts into open slots in upper leg; when ready to fish; simply remove rack from said wall, with rods and reels in place, by pushing said rack up; and placing over handle of said (5) gallon bucket handle or tackle box for easy transport.

2. (canceled)

3. (canceled)

4. (canceled)
